(19) United States
(12) Patent Application Publication
(10) Pub. No.: US 2024/0416680 A1
(43) Pub. Date: Dec. 19, 2024

(54) CASTER DEVICE

(71) Applicant: ATEC INTERNATIONAL TEAM CO., LTD., Taoyuan City (TW)

(72) Inventor: Te-Chun Chen, Taoyuan City (TW)

(73) Assignee: ATEC INTERNATIONAL TEAM CO., LTD., Taoyuan City (TW)

(21) Appl. No.: 18/221,884

(22) Filed: Jul. 14, 2023

(30) Foreign Application Priority Data
Jun. 13, 2023 (CN) 202310695700.6

(51) Int. Cl. B60B 33/00

(52) U.S. Cl. CPC B60B 33/0002; B60B 33/0042

(57) ABSTRACT

A caster device, which includes a container with a downward opening and a top plate, as well as a mounting bracket that can slide vertically inside the container. In addition, one or more casters are attached to one side of the mounting bracket and come into contact with the ground. On the other side of the mounting bracket, there is at least one elastic element pressed against the underside of the container's top plate. When a predetermined weight is applied to the object supported by the container of the caster device, the elastic element is compressed, thereby causing the bottom edge of the container to contact the ground. This increases the friction between the caster device and the ground, making the caster device not easy to move.

### FIELD OF THE DISCLOSURE

The present invention relates to a caster device, specifically a caster device designed to provide improved stability when a predetermined weight is applied to the object it supports.

### BACKGROUND OF THE INVENTION

Caster devices are widely used in various applications, such as office chairs, shopping carts, and mobile equipment, to facilitate easy movement of the objects they support. Traditionally, caster devices usually include a caster mounted on a bracket, which is then installed and fixed at the bottom of the object. Although these traditional caster devices allow for easy movement, when the user applies weight to the object being supported, such as sitting on an office chair, the caster device can also potentially cause unintended movement or instability.

To solve this problem, some caster device designs have incorporated locking mechanisms that need to be manually activated to lock the casters. However, these locking mechanisms may be inconvenient, as they require the user to manually activate or unlock them each time they move or stabilize the object.

Another method to increase the stability of a caster device is to use larger or wider casters, which can provide more contact area with the ground, and thus can generate more friction. However, larger or wider casters may not be applicable to all uses, as they may increase the overall size and weight of the caster device, making it impractical for certain objects or environments.

Therefore, an improved caster device is needed, one that can provide better stability when a predetermined weight is applied to the object it supports, without the need for manual activation or unlocking, and without the use of larger or wider casters. Therefore, how to design such a caster device is a question worth pondering by a person having ordinary skill in the art.

### SUMMARY OF THE INVENTION

The objective of the present invention is to provide a caster device that can offer improved stability when a predetermined weight is applied to the supported object.

For the above and other objectives, the present invention provides a caster device, which includes a container with a downward opening and a top plate, as well as a mounting bracket that can slide vertically within the container. In addition, one or more casters are attached to one side of the mounting bracket and make contact with the ground. On the other side of the mounting bracket, there is at least one elastic element pressed against the underside of the container's top plate. When a predetermined weight is applied to the object supported by the container of the caster device, the elastic element is compressed, causing the bottom edge of the container to contact the ground. This increases the friction between the caster device and the ground, making the caster device less likely to move. The elastic element can be a spring, for example.

In the aforementioned caster device, the container consists of an upper half-container and a lower half-container. The side walls of the lower half-container and the upper half-container each have an interlocking structure, which is used to assemble the lower half-container and the upper half-container. After assembly, the side walls of the upper half-container surround the side walls of the lower half-container.

In the aforementioned caster device, it also includes at least one rotary damper. This rotary damper is located between the side walls of the lower half-container and the upper half-container. The rotary damper contains a gear, which passes through a through hole in the side wall of the lower half-container and cooperates with the rack on the mounting bracket.

In the aforementioned caster device, the sides of the mounting bracket include slide rails, which correspond to several guide slots inside the container.

In the aforementioned caster device, it also includes a fixing screw, which is set on the container and used to secure the container to the bottom of the object.

In the aforementioned caster device, it also includes at least one buffering mechanism, where the buffering mechanism can be the aforementioned rotary damper.

In the aforementioned caster device, the caster is a twin-wheel rotating caster.

In the aforementioned caster device, the caster includes a tread made of thermoplastic rubber or polyurethane.

The foregoing, as well as additional objects, features and advantages of the invention will be more readily apparent from the following detailed description, which proceeds with reference to the accompanying drawings.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1A and FIG. 1B illustrate the 3D views of the caster device at different angles.

FIG. 2 illustrates the internal structure of the caster device.

FIG. 3 illustrates the changes of the caster device before and after being subjected to a force.

FIG. 4A shows a 3D view in an upward direction of the upper half-container.

FIG. 4B illustrates a 3D view of the lower half-container.

FIG. 5 illustrates an implementation example of the rotary damper in the present invention.

FIG. 6 illustrates an implementation example of the twin-wheel rotating caster in the present invention.

FIG. 7 illustrates another application of the caster device of this invention.

### DESCRIPTION OF THE PREFERRED EMBODIMENTS

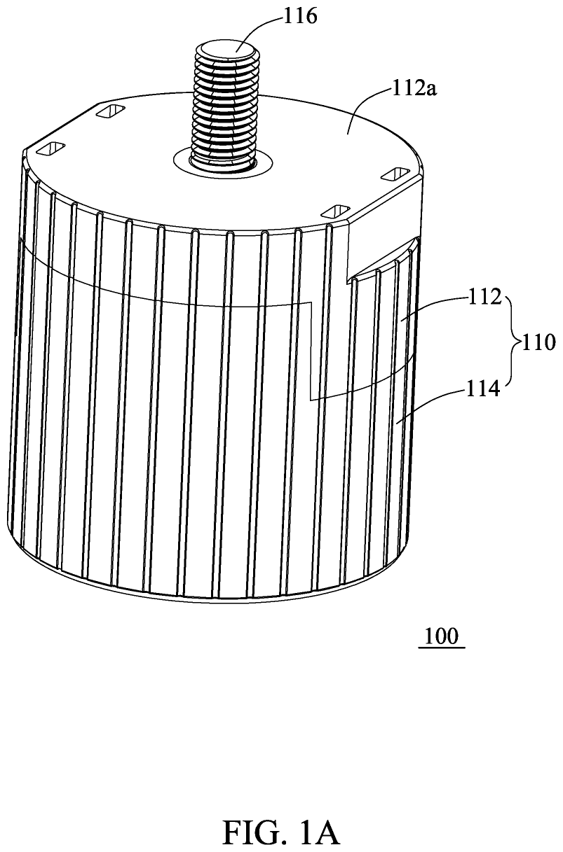

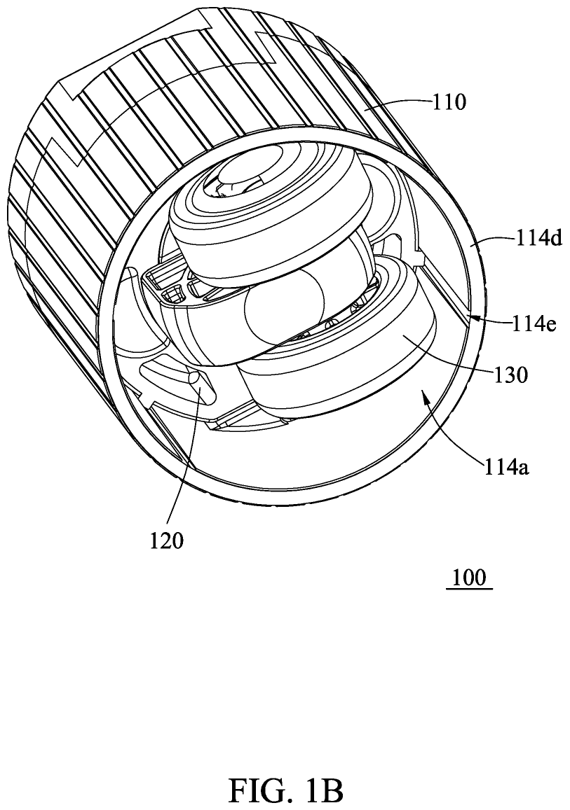

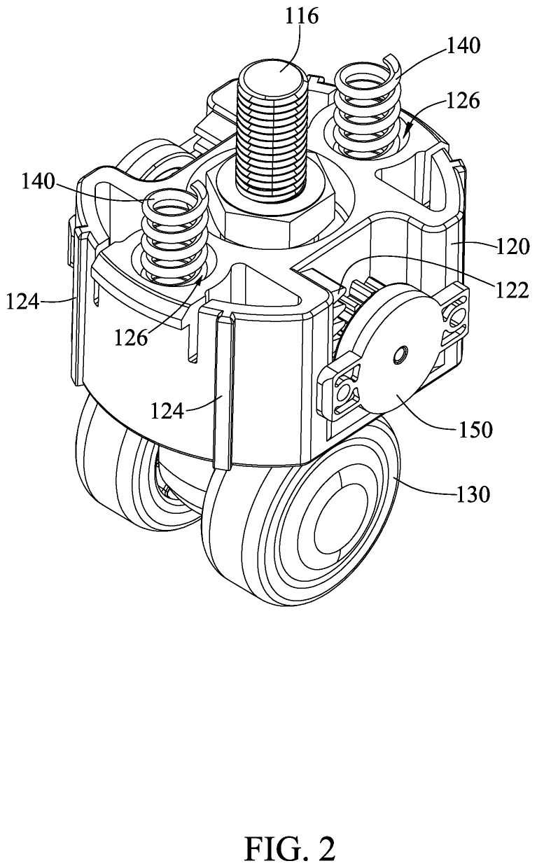

Please refer simultaneously to FIGS. 1A, 1B, 2, and 3, which illustrate an embodiment of a caster device used for supporting an object and suitable for placement on the ground. FIGS. 1A and 1B depict the caster device from different angles, FIG. 2 illustrates the internal structure of the caster device, and FIG. 3 shows the changes in the caster device before and after it is subjected to force. In this embodiment, the caster device 100 includes a container 110, which has a downward opening 114a and a top plate 112a. In addition, the caster device 100 also includes a fixing screw 116 for fixing the container 110 to the bottom of an object. In this embodiment, the object can be an office chair, a desk, or a living room sofa. By installing multiple caster devices 100 on the object, the object can be easily moved.

Please refer particularly to FIG. 2. The caster device 100 also includes a mounting bracket 120 and at least one caster 130 (two in this embodiment), wherein the mounting bracket 120 is set in the container 110 and can slide vertically within the container 110. In addition, the caster 130 is installed on one side of the mounting bracket 120 and is in contact with the ground 10. Furthermore, in this embodiment, compared to the caster 130, the elastic element 140 is on the other side of the mounting bracket 120 and there are two of them. The upper part of the elastic element 140 is pressed against the underside of the container's top plate 112a. Additionally, the mounting bracket 120 includes two spring slots 126 for installing springs (i.e., elastic elements 140).

In this embodiment, the elastic element 140 is a spring, but those of ordinary skill in the art can also choose other elastic elements. For example, the elastic element can be an elastic block or pad made of elastic material, such as rubber, silicone, or polyurethane, providing elastic support due to its inherent characteristics. Additionally, the elastic element can be a gel pad made of deformable gel material, providing soft and elastic support, helping to reduce vibration and impact. The elastic element can also be a stack of flat, curved metal strips clamped together to form a leaf spring, providing a soft yet sturdy support structure. Alternatively, the elastic element can be a torsion bar, which is a long, cylindrical metal bar that twists under force, providing elastic support through the twisting resistance of the torsion bar. The choice of elastic element depends on the requirements of a specific application, such as load-bearing capacity, shock absorption characteristics, and environmental conditions.

Please refer particularly to FIG. 3 and simultaneously to FIG. 2. When a predetermined weight is applied to the object supported by the container 110, for example, when a user sits on a chair, the force acting on the elastic element 140 causes it to be compressed. When the elastic element 140 is compressed, as the caster 130 is leaning against the ground 10 and does not produce vertical movement, the container 110 is pushed downward, causing a vertical displacement of the container 110 relative to the caster 130. This vertical displacement causes the bottom edge 114d of the container 110 to approach the ground 10. When the weight of the supported object increases, the compression of the elastic element 140 continues until the bottom edge 114d of the container 110 finally contacts the ground 10 directly. When this occurs, the contact between the bottom edge 114d and the ground 10 increases the friction between the caster device 100 and the ground 10. This increased friction makes the caster device 100 less likely to move or slide, providing stable and safe support for the supported object.

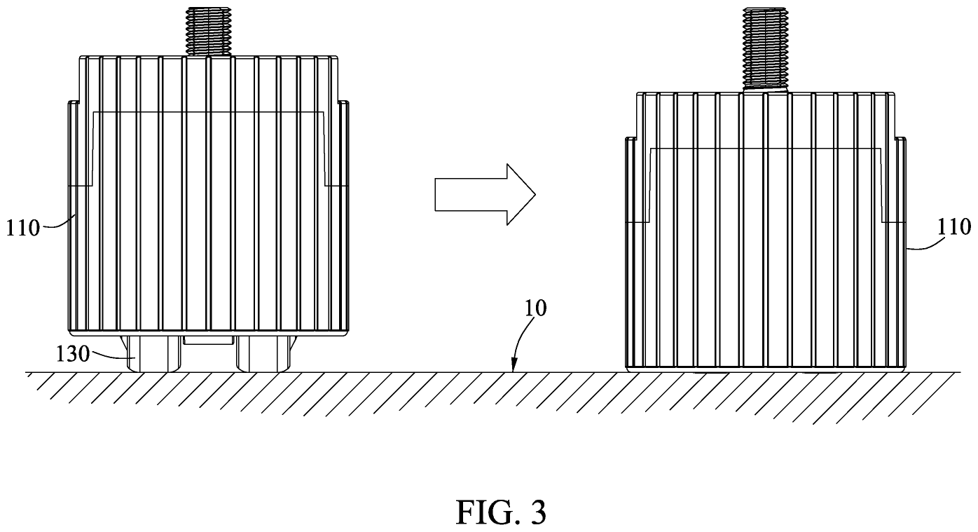

Next, please refer to FIGS. 2, 4A, and 4B simultaneously. FIG. 4A illustrates a perspective view of the top half of the container from a top view direction, while FIG. 4B illustrates a perspective view of the bottom half of the container. In this embodiment, the container 110 includes an upper half container 112 and a lower half container 114. The side walls 114b of the lower half container 114 and the side walls 112b of the upper half container 112 each have a locking structure, here referred to as the second locking structure 114c and the first locking structure 112c, respectively. The first locking structure 112c and the second locking structure 114c allow the upper half container 112 and the lower half container 114 to be assembled together. Once assembled, a part of the side wall 112b of the upper half container 112 wraps around a part of the side wall 114b of the lower half container 114.

In this embodiment, the mounting bracket 120 is designed with multiple slide rails 124 (four in this embodiment) on its two sides, which are paired with multiple corresponding grooves 114e inside the container 110. This pairing ensures smooth vertical sliding movement of the mounting bracket within the container. The slide rails 124 and grooves 114e provide enhanced stability, preventing unnecessary lateral movement or rotation when the elastic element 140 compresses and rebounds. In addition to the slide rails 124 and grooves 114e, there are various mechanisms to choose from that can enhance stability and prevent unnecessary movement or rotation of the elastic element 140 when compressed and rebounded, these include but are not limited to: ball bearing slides, telescopic slides or linear slides, and linear guides. Ball bearing slides use a set of ball bearings to enable smooth vertical movement between the mounting bracket 120 and container 110. Telescopic or linear slides feature extendable and retractable locking segments to maintain stability. Linear guides are precisely designed systems with guides and rolling elements for stable movement along a single axis. In short, those with general knowledge in the field can choose a suitable vertical linear motion mechanism based on factors such as manufacturing cost, space constraints, and desired performance.

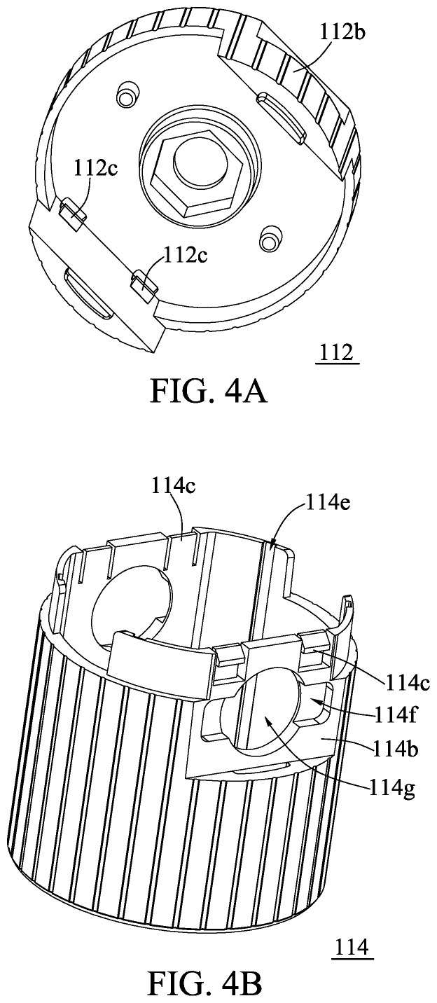

Next, please refer to FIGS. 2, 4A, 4B, and 5 simultaneously. FIG. 5 illustrates an embodiment of the rotary damper of the present invention. In this embodiment, the caster device 100 further includes at least one rotary damper 150 (two in this embodiment), which is mainly located between the side wall 114b of the lower half container 114 and the side wall 112b of the upper half container 112. As shown in FIG. 2, the mounting bracket 120 is also equipped with at least one rack 122 (two in this embodiment). In addition, as shown in FIG. 5, the rotary damper 150 includes a gear 152. This gear 152, through the through-hole 114g located on the side wall 114b of the lower half container 114 (as shown in FIG. 4B), meshes with the rack 122 on the mounting bracket 120.

In this embodiment, the primary function of the rotary damper 150 is to provide buffering and damping effects. For instance, it helps prevent situations like the chair suddenly dropping when people sit down, and bouncing back abruptly when people leave the seat. This buffering and damping effect is achieved through the coordination of the rotary damper 150 and the rack 122 on the mounting bracket. In this embodiment, the rotary damper 150 includes a main body 154, an input shaft 156 equipped with a gear 152, an output shaft (not shown), and a viscous fluid (not shown), where the output shaft and the viscous fluid are located inside the main body 154. When force is applied to an object supported by the container 110 (for example: when a person sits on the chair), the input shaft 156 of the rotary damper 150 rotates, which then drives the output shaft to rotate, and the viscous fluid generates resistance to the output shaft. This resistance produces a damping and buffering effect, helping control the object's movement, preventing sudden drops or rebounds.

In this embodiment, the rotary damper 150 is placed inside a groove 114f in the lower half container 114, and the shape of the groove 114f conforms to the shape of the main body 154 of the rotary damper 150. After placing the rotary damper 150 in the groove 114f and assembling the upper container 112 with the lower half container 114, the rotary damper 150 can be fixed between the side wall 114b of the lower half container 114 and the side wall 112b of the upper container 112 without the need for additional screws or other fixings. This effectively reduces the number of required parts and makes the appearance neater.

In addition to the rotary damper 150 described above, other types of buffering mechanisms can be used to achieve similar effects. For example, gas springs or pneumatic struts can be used as damping mechanisms. Gas springs use compressed gas (usually nitrogen) within a closed cylinder and a piston that moves according to the applied force. They provide controlled buffering, enabling smooth movement and preventing the caster device 100 from dropping or rebounding suddenly. Another possible buffering mechanism is using a friction damper, which relies on the frictional force between two surfaces (in this embodiment, the side wall 114b of the lower half container 114 and the side wall of the mounting bracket 120) to create a damping effect. Friction dampers typically consist of friction discs or plates in contact with a stationary surface. As the mounting bracket 120 moves, the friction between the surfaces dissipates energy, thereby generating smoothly controlled motion. Each of these buffering mechanisms can be adapted and integrated into the caster device 100 of this case to achieve the desired control and stability levels, ensuring smooth and safe operation while preventing sudden movement.

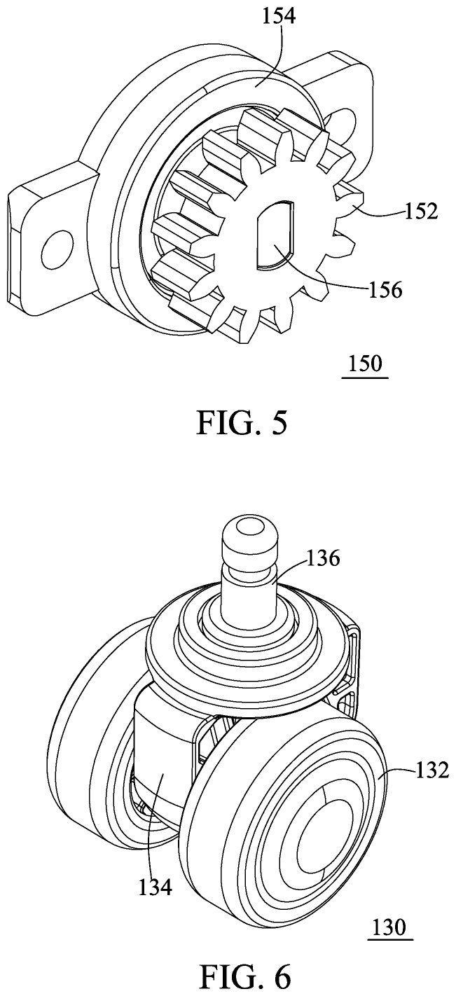

In this embodiment, a dual-wheel caster is used as an example of the caster 130. Please refer to FIG. 6, which illustrates an embodiment of the dual-wheel caster of this invention. The dual-wheel caster includes two wheels 132, mounted on a common transverse axis (not shown in FIG. 6), which is in turn installed on a mounting bracket 134. The mounting bracket 134 is attached to the bottom of the mounting bracket 120 via a mounting shaft 136. Compared to single wheel casters, dual-wheel casters provide better stability and load distribution. The dual-wheel caster is installed beneath the mounting bracket 120, allowing the wheels 132 to freely rotate around a vertical axis, enabling smooth and easy movement in any direction. The design of the dual-wheel caster has several advantages, including increasing the contact area, improving stability, and reducing the risk of the caster 130 tipping over. Additionally, the dual-wheel design improves load distribution, reducing pressure on each wheel 132 and the floor, thus decreasing wear on both the wheel 132 and the floor surface. This design also allows the caster 130 to better traverse uneven surfaces or minor obstacles, such as cracks or bumps on the ground, ensuring smooth and uninterrupted motion.

Moreover, in this embodiment, the tread of wheel 132 is also made of materials such as thermoplastic rubber or polyurethane. These materials have several advantages that can enhance the overall performance of wheel 132. Firstly, using thermoplastic rubber or polyurethane for the wheel ensures that wheel 132 generates very little noise when rolling. This characteristic is particularly important in environments where quiet operation is needed, such as offices, hospitals, or libraries. Reducing noise improves the usability of the caster device 100 and minimizes disruption to others. Furthermore, wheels 132 made of thermoplastic rubber and polyurethane provide better traction on different surfaces, including hardwood, tiles, and carpet. This enhanced traction ensures that the caster device 100 remains stable and controlled during movement, reducing the likelihood of slipping. Also, using a tread made of thermoplastic rubber or polyurethane can enhance its durability and wear resistance, as these materials are known for their elasticity and do not degrade or lose their performance characteristics even after long periods of use or under heavy loads.

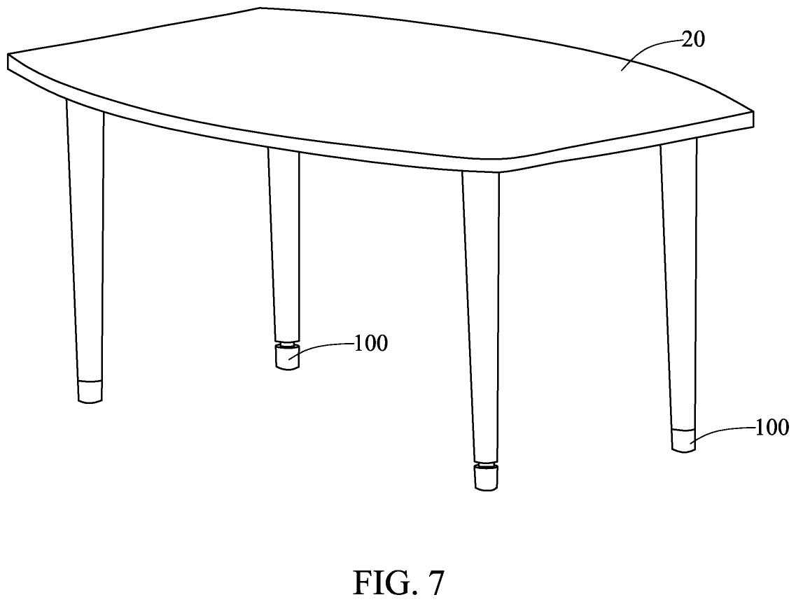

In addition, please also refer to FIGS. 1A, 2, and 7, FIG. 7 illustrates another application of the caster device of this invention. Those with ordinary skill in the art can install the caster device 100 at the four corners of a table 20 using fixing screws 116, enabling the table 20 to adapt to uneven ground. This is because when the weight of the table 20 is concentrated on one caster device 100 due to uneven ground, the elastic element 140 in that caster device 100 will be compressed, allowing the device to adapt to the uneven ground. For example, if there is a bump on the ground 10, the elastic element 140 can be compressed to maintain the level surface of the table 20. Of course, not only can it be installed on a table, the caster device 100 can also be installed on different objects (such as chairs, mobile bookcases), to achieve this automatic balancing effect.

In summary, this invention presents an innovative caster device that features two half containers, equipped with an elastic element and a mounting bracket. With this design, when a predetermined weight is applied to the supported object, better stability can be provided without the need for manual activation or unlocking, and without the use of larger or wider casters. Furthermore, the combination of the slide rail and the guiding slot, along with the use of the rotary damper, further enhances the stability of the caster device and control during the compression and rebound process of the elastic element. Additionally, other embodiments of this invention may also use various buffering mechanisms to achieve the same effect as the rotary damper.

In the aforementioned embodiments, the design of the caster device allows it to be assembled without screws (though the invention does not limit the use of screws or additional fixtures), facilitating easy assembly and disassembly. The choice of tread material for the caster, such as thermoplastic rubber or polyurethane, ensures that the caster generates the minimum noise when rolling on the ground. This is particularly important for environments that require quiet operation, such as offices, hospitals, or libraries.

In conclusion, this invention demonstrates an innovative and multifunctional caster device suitable for various applications, such as office desks and chairs, medical equipment, etc. It enhances the comfort and satisfaction of users while ensuring optimal performance and reliability.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A caster device for supporting an object and suitable for placement on a ground surface, the caster device comprising:
a container including a downward opening and a top plate;
a mounting bracket, set within the container and suitable for vertical sliding within the container;
at least one caster, fixed on one side of the mounting bracket and in contact with the ground surface;
at least one elastic element, located on the other side of the mounting bracket, and pressed against a bottom surface of the top plate of the container;
wherein, when a predetermined weight is applied to the object supported by the container, the elastic element is compressed, the bottom edge of the container contacts the ground surface, thereby increasing the friction between the caster device and the ground surface, making the caster device difficult to move.

2. The caster device according to claim 1, wherein the elastic element is a spring.

3. The caster device according to claim 1, wherein the container includes an upper half container and a lower half container, a side wall of the lower half container and a side wall of the upper half container each have an interlocking structure, the lower half container and the upper half container are assembled through the interlocking structure.

4. The caster device according to claim 3, further including at least one rotary damper, located between the side wall of the lower half container and the side wall of the upper half container, the rotary damper includes a gear, the gear passes through a through hole in the side wall of the lower half container and cooperates with a rack on the mounting bracket.

5. The caster device according to claim 1, wherein the side wall of the mounting bracket includes multiple slide rails and cooperates with corresponding multiple grooves within the container.

6. The caster device according to claim 1, further including a fixing screw, the fixing screw is set on the container, used to fix the container to the bottom of the object.

7. The caster device according to claim 1, further including at least one buffering mechanism.

8. The caster device according to claim 7, wherein the buffering mechanism is a rotary damper.

9. The caster device according to claim 1, wherein the caster is a double wheel rotating caster.

10. The caster device according to claim 9, wherein the caster includes a tread made of thermoplastic rubber or polyurethane.

11. The caster device according to claim 1, wherein the caster includes a tread made of thermoplastic rubber or polyurethane.
